(19) United States
(12) Patent Application Publication
(10) Pub. No.: US 2005/0030175 A1
(43) Pub. Date: Feb. 10, 2005

(54) Security apparatus, system, and method

(76) Inventor: Daniel G. Wolfe, Highland, UT (US)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/636,348

(22) Filed: Aug. 7, 2003

(51) Int. Cl. G08B 1/08

(52) U.S. Cl. 340/539.13

(57) ABSTRACT

A monitoring device for monitoring property includes a plurality of detection sensors that monitor conditions proximate to property using the detection sensors. The monitoring device detects unusual conditions and initiates communication with a user transceiver via a transceiver coupled to the monitoring device. Once communication is established, the user may monitor conditions proximate to the monitoring device. The monitoring device includes a location identifier, such as a tracking transmitter that emits a signal that facilitates locating the monitoring device. The monitoring device further includes a central processing unit to facilitate receiving programming commands from a user through the user transceiver to customize the security parameters of the monitoring device.

### BACKGROUND OF THE INVENTION

1. The Field of the Invention

The invention relates to devices, methods, and systems for improving security. Specifically, the invention relates to devices, methods, and systems for providing automated information regarding the status and location of fixed or mobile property.

2. The Relevant Art

Many personal, corporate, or government property items are vulnerable to theft or vandalism with no effective economical means of protection. Security systems that monitor the premises of a property are usually expensive and typically ineffective. Such monitoring security systems are also typically immobile and slow to respond to trouble. Once informed of stolen or vandalized property, law enforcement personnel are often too busy to investigate such crimes due to their heavy workloads. Thieves and vandals of small items are seldom caught, and the personal property is seldom recovered.

Currently available security systems typically require the owner to be physically present to activate or deactivate the security system. The requirement of being physically present has proven to be cumbersome for owners, particularly when the security system is placed at a job location, such as a construction site, that might be located far from the owner of the security system. When a security system is activated, the owner may be required to go to the location, and manually reset the system.

Furthermore, current security systems often notify a security company designated to that security system. Notifying a designated security company often proves to be ineffective in that security companies will automatically notify local authorities whenever the security system is activated. Oftentimes, the notification is a false alarm and the authorities are required to inspect the location, wasting valuable time.

What is needed is a device for securing property that is portable, simple, inconspicuous, effective, and economical. Such a device could be attached to a property item, and would be highly effective in providing notification directly to the owner of the device regarding disturbances to property. Such a device would inconspicuously protect a wide array of property, including, without limitation, vehicles, power tools, bicycles, trailers, boats, stereos, televisions, and the like. In response to a property disturbance, such a device would be effective to provide instant notification of the disturbance to the owner, provide real time tracking information regarding any movement of the property to enable identification and apprehension of the perpetrator(s), and enable quick recovery of the property. Also such a unit should be programmable to automatically turn off and on at specific times of the day.

In addition to the aforementioned attributes, what is further needed is a device that may be programmed from any remote location. Such a device could conveniently be programmed at any time from a remote location, and would eliminate the need for an owner to travel to the property and reset or program the various elements contained within the security system.

### SUMMARY OF THE INVENTION

The various elements of the present invention have been developed in response to the present state of the art, and in particular, in response to the problems and needs in the art that have not yet been fully solved by currently available security systems. Accordingly, the present invention provides an improved apparatus, method, and system for providing security to property locations and items.

In one aspect of the present invention, a method for improving security includes attaching a transceiver to a central processing unit, receiving programming commands from a user transceiver, contacting the user transceiver to provide information pertaining to one or more monitoring devices, and transmitting a signal configured to facilitate locating one or more monitoring devices. In one embodiment, the method further includes monitoring the status of property, and sending security related information to a user by way of a user transceiver.

The method of improving security provides a user, such as a property owner, with security information necessary to take appropriate measures regarding the security of the monitored property. In one embodiment, the security related information provided to a user transceiver includes directions to, distance to, location of, and status of one or more monitoring devices. In a second embodiment, the security related information provided to a user transceiver includes the status information regarding a condition proximate to one or more monitoring devices. The method for improving security empowers a user to respond intelligently to property disturbances.

In another aspect of the present invention, a mobile monitoring device includes a central processing unit, a transceiver coupled to the central processing unit, and a tracking transmitter configured to facilitate locating the monitoring device. In one embodiment, the transceiver is configured to receive programming commands from a user transceiver, and send information to the user transceiver in response to a condition proximate to the monitoring device. The monitoring device interacts with a user, monitors local conditions, and provides security information to the user.

The monitoring device includes one or more detection sensors configured to monitor a condition proximate to the monitoring device. Examples of detection sensors include but are not limited to a motion sensor, a shock sensor, an audible sensor, a water sensor, a fire sensor, and a detachment sensor. The detection sensors facilitate providing security related information regarding one or more monitoring devices to a user through a user transceiver.

In selected embodiments, the monitoring device further includes a voice module configured to record and play a message pertaining to the monitoring device, or a condition proximate to the monitoring device. In one embodiment, the voice module includes a microphone, speakers, and the like. Monitoring devices may reside at construction sites, houses, stores, or the like. Other monitoring devices may include still or video cameras. In certain embodiments, the transceiver within a monitoring device comprises a cellular telephone that enables a user to contact, or be contacted by, the monitoring device through a user transceiver. In one embodiment, the user transceiver may be a telephone, computer terminal, PDA, or the like. Once connection between the user transceiver and one or more monitoring devices has been established, a user may receive security information and provide programming commands to the monitoring device. Programming commands may be used to activate sirens, strobe lights, speakers, etc.

Various elements of the present invention are combined into a system for improving security. In one embodiment, the system includes a central processing unit and a transceiver coupled to the central processing unit. The transceiver is preferably configured to receive programmable commands from a user transceiver and to contact the user transceiver in response to a condition proximate to one or more monitoring devices. The system may further include a tracking transmitter configured to transmit a tracking signal locatable by a user, a detection sensor configured to monitor a condition proximate to one or more monitoring devices, a camera configured to collect still or video photo info, a timing module configured to automatically enable one or more monitoring devices, and a microphone configured to collect audible information proximate to one or more monitoring devices.

The present invention facilitates providing information to a user such as the location of, status of, and directions to a monitoring device. The present invention also provides a user with the option of providing programming commands to a monitoring device that activates the various options or features.

The various elements and aspects of the present invention provide information regarding the status of one or more monitoring devices placed to monitor property and conditions proximate to the property. The present invention increases security by providing information necessary to take appropriate measures to ensure the security of the physical property. These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram illustrating one embodiment of a security system of the present invention;

FIG. 2 is a block diagram illustrating one example of a monitoring device of the present invention;

FIG. 3 is a flow chart illustrating one embodiment of a programming method of the present invention;

FIG. 4 is a flow chart illustrating one embodiment of a monitoring method of the present invention; and

FIG. 5 is a block diagram illustrating one example of a security system in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

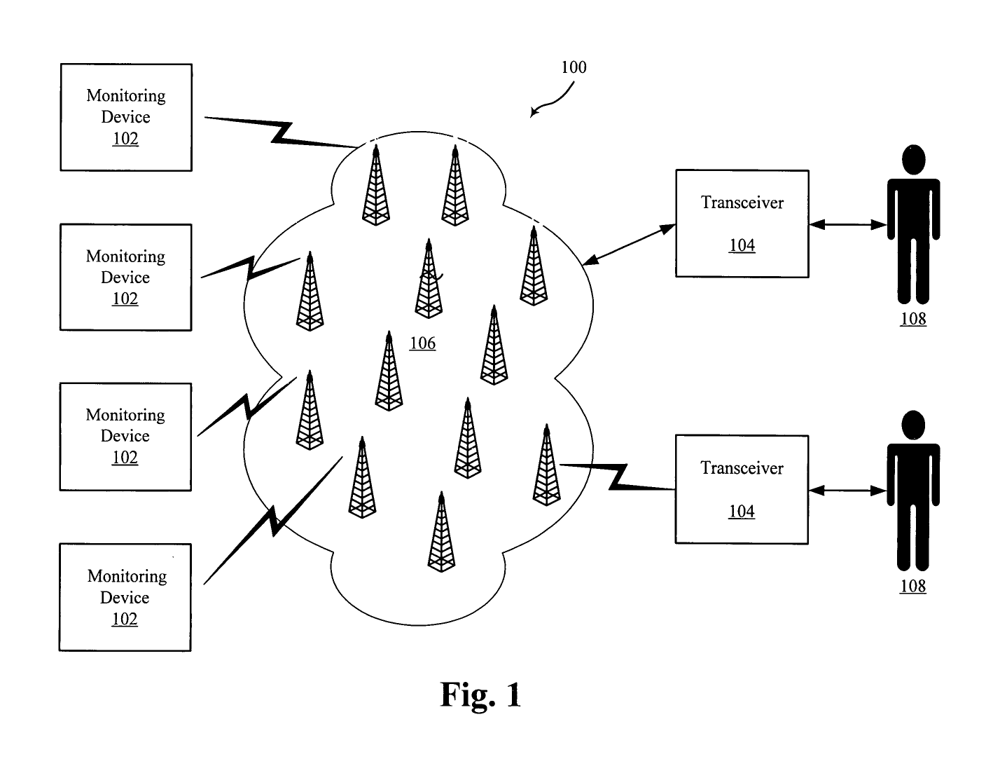

Referring to FIG. 1, a mobile security system 100 addresses many of the problems and issues inherent in the prior art security systems as discussed in the background section. The security system 100 includes one or more monitoring devices 102, and one or more transceivers 104. As depicted, the monitoring devices 102 and the transceivers 104 communicate by way of a communications medium such as a mobile communications network 106. The depicted security system 100 provides information to a user 108 pertaining to a condition of one or more monitoring devices 102.

The depicted monitoring devices 102 are configured to monitor conditions relating to real property or equipment, and provide information regarding those conditions to a user with the use of one or more transceivers 104. The monitoring devices 102 may, for example, monitor construction sites and equipment commonly found at construction sites. In so doing, the monitoring devices 102 may detect fires, floods, movement, and other disturbances caused by people, nature, animals, or the like.

The monitoring devices 102 may establish communication with one or more transceivers 104 by way of the communications network 106. In one embodiment, the monitoring devices 102 establish communication with one or more transceivers 104 upon detecting movement at or near a construction site. The transceivers 104 are configured to interact with a user 108 and may include telephones, computer terminals, PDA's, televisions, radios, speakers, or the like. The monitoring devices 102 monitor events such as the location and status of the property being monitored and communicate information regarding the events through the transceivers 104.

In one embodiment, a transceiver 104 interacts with a user 108 using verbal communication. The verbal communication may include directions to and the location of the property being monitored. The verbal communication may further include real-time or deferred audio or video information gathered by one or more monitoring devices 102. Additionally, audio information may be used to allow a user 108 to listen to sounds in the environment of the property being monitored. Indeed, the very conversations of thieves may be monitored with this feature without the thieves being aware of any surveillance.

In one example of operation, a monitoring device 102 may monitor the area of a construction site and the equipment found thereon. Upon detecting a disturbance, one or more monitoring devices 102 may initiate communication with one or more transceivers 104 by way of the communication network 106. A user 108 may then access the transceiver 104 and be provided with information such as the location of, and directions to, the construction site. Further, the monitoring devices 102 may provide real-time or deferred audio or video information to the transceiver 104. The audio or video information enables a user 108 to monitor conditions at the construction site by way of the transceiver 104. A user 108 may then proceed to take appropriate action to secure the construction site and the equipment stored at the construction site.

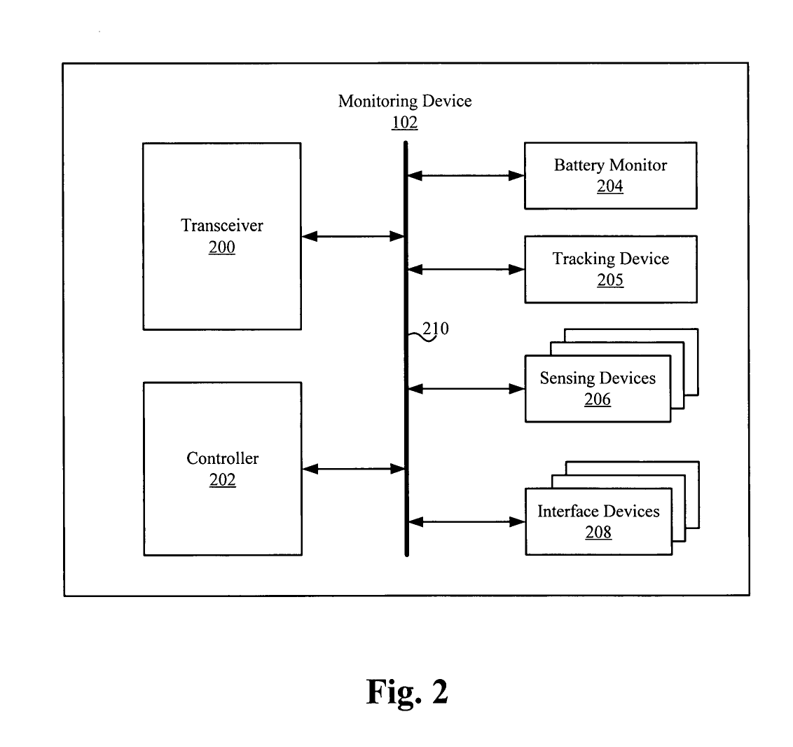

FIG. 2 is a block diagram further illustrating specific elements of one embodiment of the security system 100 of FIG. 1. The security system 100 improves the security of property by providing information to a user 108 pertaining to the location and status of the property being monitored by the monitoring device 102.

The depicted monitoring device 102 includes a transceiver 200, a controller 202, a battery monitor 204, a tracking device 205, a plurality of sensing devices 206, and a plurality of interface devices 208. The various elements of the monitoring device 102 may communicate on a central bus 210. The transceiver 200 may be a cellular telephone that facilitates communication between the monitoring device 102 and a user 108. One example of a cellular telephone that may be used as the transceiver 200 is the Nokia 5165 cellular telephone, though any cellular telephone, hardwired, or wireless device may be used. Communications may also be conducted over the Internet. The communication may include verbal, tactile, and visual interaction.

The controller 202 is a microprocessor that interacts with the transceiver 200 to provide information regarding the additional elements of the monitoring device 102, such as the power status of the battery, the status of the sensing devices 206, the status of the tracking device 205, and the status of the interface devices 208 to a user 108. The controller 202 may also interact with the transceiver 200 to provide programming commands to the additional elements of the monitoring device 102.

The additional elements within the monitoring device 102 may provide information to a user 108 by way of the transceiver 200, as previously explained. The battery monitor 204 provides information regarding the power supply of the monitoring device 102 to a user 108. The tracking device 205 provides information regarding the location of the monitoring device 102 to a user 108. In one embodiment, the tracking device 205 is a GPS device that provides the geographical coordinates of the monitoring device 102 to a user 108. In a second embodiment, the tracking device 205 is an RF transmitter that transmits radio frequency waves in order to enable a user 108 to locate the monitoring device 102.

As depicted, the monitoring device 102 includes a plurality of sensing devices 206 that provide information regarding the status of the property being monitored by the monitoring device 102 to a user 108. The information provided by the sensing devices 206 to a user 108 may also include information pertaining to the status of the monitoring device 102. The sensing devices 206 include, but are not limited to, magnetic sensors, shock sensors, motion sensors, temperature sensors, water sensors, sound sensors, smoke sensors, video sensors, and the like.

The interface devices 208 facilitate interfacing between the monitoring device 102 and a user 108. In one embodiment, the interface devices 208 include a voice module. The voice module provides audible information to a user 108 regarding the monitoring device 102 and the property being monitored by the monitoring device 102. The interface devices 208 may also include devices for interfacing with other equipment such as recording devices, on-site alarm systems, and the like.

The monitoring device 102 interacts with a user 108 to provide information regarding the monitoring device 102 and the property being monitored by the monitoring device 102. In one embodiment, the battery monitor 204 interacts with the controller 202 when the power supply of the battery has reached a pre-determined low power threshold value. The controller 202 interacts with the transceiver 200 to provide a command to contact a user transceiver 104. The transceiver 200 interacts with a user 108 by initiating a telephone call to a user transceiver 104. The controller 202 may also interact with the interface devices 208, such as a voice module, by providing a command to provide audible information to a user transceiver 104 through the transceiver 200 regarding the status of the battery power supply being monitored by the battery monitor 204. Providing information regarding the status of the battery power supply informs a user 108 as to when recharging the battery of the monitoring device 102 is necessary.

A sensing device 206 may interact with the controller 202 when that particular sensing device 206 is activated. For example, a monitoring device 102 may be placed at a typical construction site. A sensing device 206, such as a motion sensor may be activated by moving an object proximate to the monitoring device 102, or by moving the actual monitoring device 102. The sensing devices 206 interact with the controller 202 to provide information regarding conditions proximate to the monitoring device 102.

The controller 202 interacts with the tracking device 205 by providing a command to initiate transmitting signals that enable a user 108 to locate the monitoring device 102. For example, the controller 202 may interact with the transceiver 200 to provide a command to initiate a telephone call to a user transceiver 104. The transceiver 200 initiates a telephone call to a user transceiver 104 and a user 108 is able to obtain information regarding the status and location of the monitoring device 102 and the status of the property being monitored by the monitoring device 102.

In one embodiment, the monitoring device 102 is programmable to automatically turn on and off at selected times. An internal timing circuit or other clock device may be used to trigger the automatic functions. The programming may be conducted locally, by hand, or remotely. Thus, in one embodiment, the user may program the unit to turn itself off (sleep mode) automatically during working hours and automatically back on (alarm active mode) during night and weekend hours.

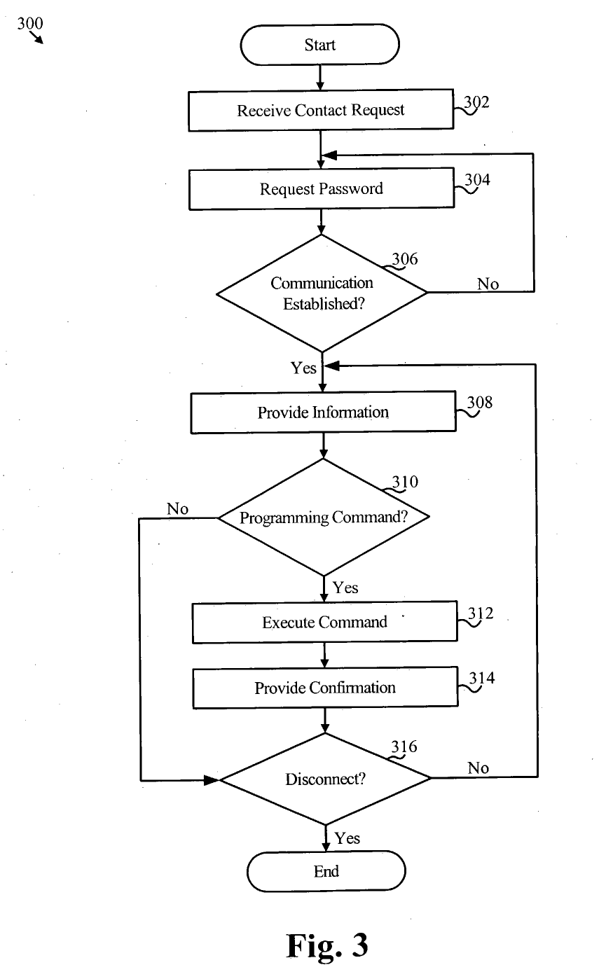

During sleep mode, when the unit is not active, one or more sensors may still be programmed to recognize an unauthorized tampering, removal of the unit, or attempted destruction of the unit. The sensors may be magnetic or shock sensors. When the sensor recognizes an unauthorized tampering, it activates the unit and initiate a call to the owner alerting him or her of the unauthorized tampering or attempted removal or destruction of the unit. FIG. 3 is a flow chart illustrating one embodiment of a security system programming method 300 of the present invention. The security system programming method 300 facilitates providing programming commands to one or more monitoring devices 102 of the security system 100.

In the depicted embodiment, the security system programming method 300 includes a contact step 302, a request password step 304, a communication test 306, a provide information step 308, a command test 310, an execute step 312, a confirmation step 314, and a disconnect test 316.

The method begins by contacting 302 the transceiver 200. In one embodiment, contacting 302 the transceiver 200 is conducted by a user transceiver 104 which includes, but is not limited to, a telephone, radio, computer terminal, modem, and the like. In response to reception of a contact request from a user transceiver 104, the method 300 proceeds to request a password 304. Requesting a password 304 facilitates a user 108 to enter a password specific to the transceiver 200 within the monitoring device 102 being contacted. If the password entered is correct, the method 300 proceeds to determine if communication 306 has been established between the user transceiver 104 and the transceiver 200. If the password entered is incorrect, the method 300 returns to request a password 304.

After communication between the transceiver 200 of the monitoring device 102 and a user transceiver 104 has been established, the method 300 proceeds to provide information 308 to a user transceiver 104 regarding the monitoring device 102. The information may include status information such as the status of the battery being monitored by the battery monitor 204, location information provided by the tracking device 205, and condition information provided by the sensing devices 206. The interface devices 208, such as a voice module, may provide the information audibly to a user 108 through the user transceiver 104.

Providing information 308 informs a user 108 as to the status of the various elements of one or more monitoring devices 102, the location of one or more monitoring devices 102, and condition information regarding conditions proximate to one or more monitoring devices 102. Furthermore, providing information 308 may include providing instructions to a user 108 regarding programming commands supported by one or more monitoring devices 102.

The method 300 proceeds to the command test 310. The command test 310 ascertains whether a programming command has been provided by the user 108 through the user transceiver 104. If a programming command has been provided the security system programming method 300 proceeds to execute 312 the command. In one embodiment, the programming commands are received and executed 312 by the transceiver 200. In a second embodiment, the programming commands are received by the transceiver 200 and executed 312 by the controller 202. The programming commands may include activating or deactivating one or more monitoring devices 102 of the security system 100 at specific times as programmed by a user 108. If a user 108 does not provide a programming command, the method 300 jumps to the disconnect test 316.

In a further embodiment, programming commands are provided to activate or deactivate the various elements contained within one or more monitoring devices 102, such as the battery monitor 204, the tracking device 205, the sensing devices 206, and the interface devices 208. For example, a user 108 may provide programming commands through a user transceiver 104 to activate or deactivate the various sensing devices 206 of the monitoring device 102. A user 108 may also provide programming commands to one or more interface devices 208, such as a voice module, to facilitate recording information to be played back to a user 108 regarding the status of one or more monitoring devices 102.

Once the programming commands have been executed 312, the method 300 proceeds to confirm 314 that the programming commands provided by a user 108 have been executed 312. In one embodiment, the interface devices 208, such as a voice module, provide audio confirmation that the programming commands provided by a user 108 have been executed. In a second embodiment, text confirmation is provided to a user transceiver 104 by sending text messages by way of the transceiver 200. Confirming 314 facilitates a user 108 to become aware if programming commands have been received at the command test 310, and if the programming commands have been executed 312.

The method 300 continues to the disconnect test 316. If a user such as the user 108 chooses to disconnect 316 with the transceiver 200 of one or more monitoring device 102, the method 300 ends. If a user does not disconnect 316 with the transceiver 200, the method 300 loops to provide information 308 and repeats the aforementioned sequence beginning at step 308.

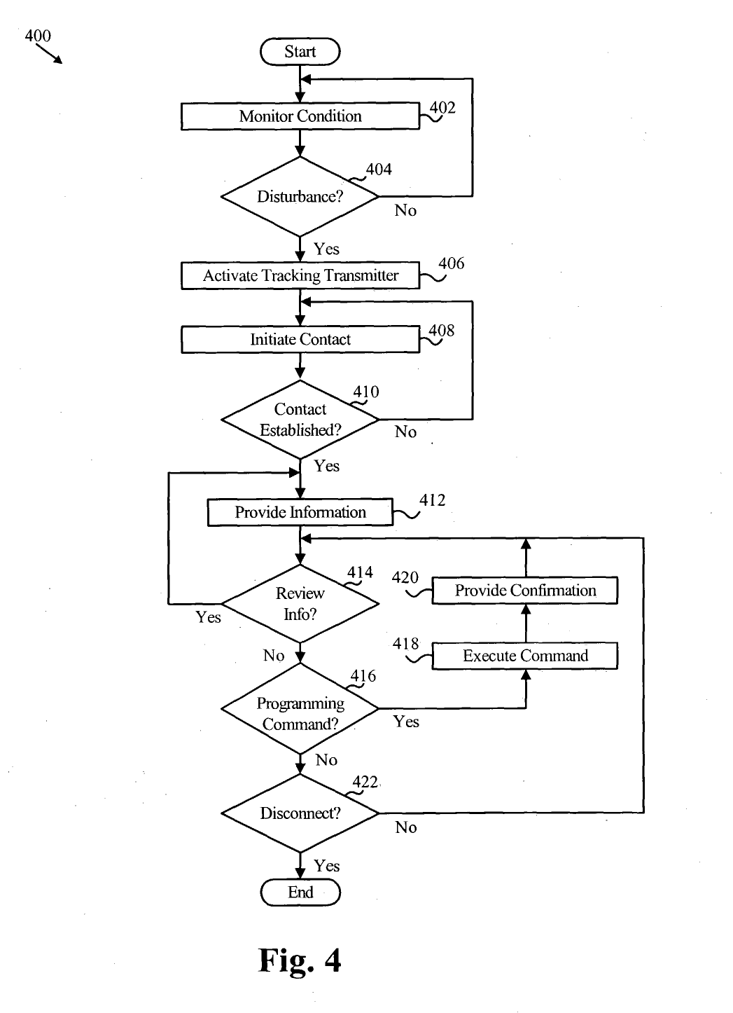

FIG. 4 is a flow chart illustrating one embodiment of a monitoring method 400 in accordance with the present invention. The monitoring method 400 may be conducted in conjunction with one or more monitoring devices 102 of the security system 100 of the present invention. The monitoring method 400 facilitates one or more monitoring devices 102 providing information such as status, condition, and location information to a user.

In the depicted embodiment, the monitor method 400 includes a monitor step 402, a detection test 404, a tracking step 406, a contact step 408, a communication test 410, a provide information step 412, a review test 414, a command test 416, an execute step 418, a confirmation step 420, and a disconnect test 422.

The method 400 begins, and one or more monitoring devices 102 of the security system 100 monitor 402 property. In one embodiment, the property being monitored 402 is a construction site. For example, one or more monitoring devices 102 may be dispersed throughout various locations within a construction site to facilitate monitoring 402 the area for possible intruders, animals, natural disasters such as floods, fires, and the like. One or more monitoring devices 102 may also be placed near or attached to moveable property such as equipment and tools typically found at a construction site.

The method proceeds to detect 404 whether a disturbance or similar event has occurred. If no disturbance or similar event has occurred, the method loops to monitor 402 the property by way of the monitoring devices 102. If a disturbance or similar event has occurred, the method proceeds to initiate tracking signals 406. In one embodiment, initiating tracking signals 406 includes activating the tracking device 205 which begins to transmit radio frequency waves that facilitate locating the monitoring device 102 by the user 108 or the like. In a second embodiment, the tracking device 205 is a GPS device and transmits the geographical coordinates of the monitoring device 102 to a user transceiver 104 such as a PDA, computer, GPS receiver, cell phone, or the like.

In response to initiating tracking 406, the method 400 continues by contacting 408 the user transceiver 104 by way of the transceiver 200. The communication test 410 ascertains whether communication has been established, for example between the transceiver 200 of the monitoring device 102 and the user transceiver 104. If communication has not been established, the method continues to attempt to establish communications by contacting 408 the user transceiver 104.

In one embodiment, contacting 408 the user transceiver involves automatically dialing a preprogrammed list of telephone numbers stored in memory. If communication is not established by dialing the first preprogrammed telephone number, the method loops from the communication test 410 and continues to attempt to contact 408 the user transceiver 104 by dialing the next available preprogrammed telephone number stored in memory. The process is repeated until communication has been established, for example between the transceiver 200 and the user transceiver 104.

In response to establishing communication, the method 400 proceeds by providing information 412 such as status, location, and condition information collected by one or more monitoring devices 102 to the party with which communication has been established. In one embodiment, a password is verified previous to providing 412 the collected information.

The information provided to a user transceiver 104 may be audio information pertaining to the property being monitored. For example, a user transceiver 104 may include a telephone that facilitates a user 108 to listen to audio information proximate to a monitoring device 102. The audio information may be also collected from an interface device 208 such as a microphone. The audio information may further be processed by the controller 202 and transmitted by the transceiver 200 to a user transceiver 104 such as a telephone. The audio information enables a user 108 to listen to the status surrounding the property being monitored by one or more monitoring devices 102. The information provided to a user transceiver 104 may also be information regarding the location of the monitoring device 102.

The review information test 414 ascertains whether a user 108 requests to review the information provided to the user transceiver 104 regarding the monitoring device 102. If a user 108 selects to review the information, the method proceeds to provide information 412. If the user 108 does not request to review the information, the method 400 proceeds to the command test 416.

The command test 416 ascertains whether the user 108 or the like has issued a programming command. If no programming command has been issued, the disconnect test 422 ascertains whether communication between the transceiver 200 of the monitoring device 102 and the user transceiver 104 has been disconnected. If communication has not been disconnected, the method 400 loops to the review information test 414 to determine if a user 108 has selected to review information provided 412 by the monitoring device 102. If communication between the transceiver 200 and the user transceiver 104 has been disconnected, the method 400 ends.

In one embodiment, if the command test 416 ascertains that a user 108 or the like has issued a programming command, such as a command to turn on speakers, a strobe light, sirens, or the like, the command is executed 418 by the monitoring device 102. Upon execution of the programming command, a confirmation is sent 420 to a user 108 or the like.

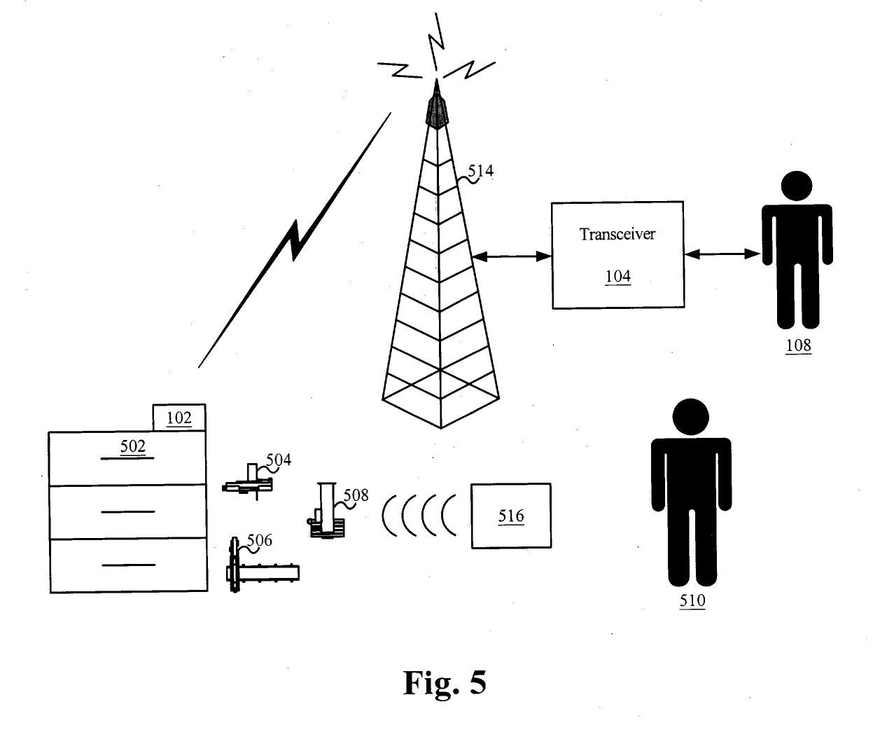

FIG. 5 is a block diagram illustrating one example of a security system 500 in accordance with the present invention. The depicted security system 500 is one example of a system useful for conducting the monitoring method 400 described in FIG. 4. As depicted, the security system 500 includes the monitoring device 102, a communications tower 514, and a user transceiver 104. In the depicted embodiment, the user transceiver 104 is a telephone. In the depicted embodiment, the monitoring device 102 is placed to monitor a typical construction site. In one embodiment, the construction site includes a tool bench 502, and typical construction tools 504, 506, and 508. The depicted block diagram further illustrates a possible intruder 510. In one embodiment, one or more monitoring devices 102 are dispersed throughout various locations within the construction site. In the depicted embodiment, the monitoring device 102 is attached inconspicuously to the tool bench 502. Additional monitoring devices 102 may also be placed in various locations throughout the construction site. In the depicted embodiment, the monitoring device 102 monitors the area proximate to the construction tools 504, 506, and 508. As previously explained, a user 108 interacts with the monitoring device 102 by way of the user transceiver 104.

The user 108 may provide programming commands to activate or deactivate the various elements or features within the monitoring device 102 such as the battery monitor 204, the tracking device 205, the sensing devices 206, and the interface devices 208. The programming commands are transmitted from the user transceiver 104 to the monitoring device 102 by way of a communications medium such as the communications tower 514. In one embodiment, the communications tower 514 includes a cellular telephone tower. Transmission of the programming commands facilitate a user 108 to remotely provide custom programming commands specific to each monitoring device 102 placed at a given location, such as a construction site.

After a user 108 has provided the desired programming commands, and the monitoring device 102 is activated, the monitoring device 102 monitors the construction site and the construction tools 504, 506, and 508. In one embodiment, the sensing devices 206 within the monitoring device 102 are activated. For example, a sensing device 206 such as a motion detection sensor, detects motion from the possible intruder 510. Upon activation of the sensing devices 206 the tracking device 205 is activated, and the monitoring device 102 proceeds to initiate contact with the user transceiver 104 as discussed in FIG. 4.

Furthermore, a monitoring device 102 may be attached to one or more specific construction tool 504, 506, and 508. In one embodiment, the intruder 510 moves the specific construction tool 504, 506, and 508 to which the monitoring device 102 is attached, the tracking device 205 within the monitoring device 102 is activated, and the monitoring device 102 initiates contact with the user transceiver 104. Activation of the tracking device 205 enables signals to be transmitted that facilitate a user 108 to locate the monitoring device 102. Contacting a user by way of the transceiver 104 enables the user 108 to receive information regarding the status of the monitoring device 102 that initiated the contact.

For example, the information may be audio information collected from an interface device 208 such as a microphone, or from an internal microphone of the transceiver 200 within the monitoring device 102. The user 108 is able to hear the status of the property proximate to the monitoring device 102. The information provided to the user 108 may also be the location of the monitoring device 102 that initiated the contact. The user 108 is provided with information necessary to take appropriate measures such as contacting local authorities. If the user 108 determines the contact from the monitoring device 102 to be a false alarm, the user 108 may provide programming commands from the user transceiver 104 to one or more monitoring devices 102 such commands to reset the tracking device 205, deactivate a sensing device 206, and deactivate an interface device 208, or the like. If the alarm is not a false alarm, the user 108 may choose to enter commands to turn on sirens, lights, speakers, etc. This may be conducted in one embodiment using buttons of a cell phone or conventional phone.

The depicted security system 500 enables a user to provide programming commands to one or more monitoring devices 102 from a user transceiver 104 which may be at a remote location. The security system 500 also provides information to one or more user transceivers 104 through one or more monitoring devices 102 regarding the status of a property being monitored by one or more monitoring devices 102.

In a further embodiment, the monitoring device 102 can operate from a remote site and maintain contact with satellite units 516. The satellite units maybe attached to the tools 504, 506, 508. Each satellite unit 516 preferably communicates with the monitoring device 102 and maintains this communication so that the monitoring device 102 can detect any change in the condition of the satellite unit 516. For instance, the satellite unit 516 may use an infrared or radio wave or other type of communicating medium to keep in contact with the monitoring device 102. When the satellite device 516 undergoes a change in condition, whether by flood, fire, theft, etc., that communication is interrupted, thereby notifying the monitoring device 102 that the condition has changed. The monitoring device 102 then contacts the user in the method described above. The satellite device 516 may also be remotely programmed through the monitoring device 102. Indeed, a plurality of such satellite devices 516 may be thus programmed, activated, deactivated, etc. with a single phone call or other contact to the centralized monitoring device 102. The satellite devices 516 may be provided with tracking units to notify either the centralized monitoring device 102, or the user directory, of its location or change of status. Indeed, any of the functions discussed above for the monitoring device 102 may be incorporated into the satellite device 516.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A mobile monitoring device for monitoring property comprising:
a central processing unit;
a transceiver coupled to the central processing unit;
the transceiver configured to receive programming commands from a user transceiver; and
the transceiver further configured to transmit information to the user transceiver related to a condition of the property being monitored by the monitoring device.

2. The monitoring device of claim 1 further comprising a tracking device, wherein the tracking device is configured to transmit a signal for locating the monitoring device.

3. The monitoring device of claim 1, further comprising a voice module configured to record and play a message corresponding to a condition of the property being monitored by the monitoring device.

4. The monitoring device of claim 1, wherein the transceiver utilizes a cellular frequency band.

5. The monitoring device of claim 1, wherein the transceiver is further configured to trigger an alarm responsive to a remote programming command from the user transceiver.

6. The monitoring device of claim 1, further comprising a sensing device configured to monitor a condition of the property.

7. The monitoring device of claim 6, wherein the sensing device is selected from the group consisting of a motion sensor, a shock sensor, an audible sensor, a water sensor, a fire sensor, and a detachment sensor.

8. The monitoring device of claim 2, wherein the tracking device is an RF transmitter.

9. The monitoring device of claim 2, wherein the tracking device is a GPS device.

10. The monitoring device of claim 1, wherein the monitoring device is configured such that it may be attached to the property.

11. The monitoring device of claim 1 wherein the monitoring device may be programmed to turn off and on at specified times.

12. The monitoring device of claim 1, further comprising an interface device.

13. The monitoring device of claim 12 wherein the interface device is a microphone that is configured to collect audible information proximate to the monitoring device.

14-17. (cancelled)

18. A mobile monitoring device for monitoring property comprising:
a controller means; a transceiver means for receiving programming commands from a user transceiver, the transceiver means configured to contact the user transceiver to provide information pertaining to a condition of the property being monitored by the monitoring device, the transceiver means being in electronic communication with the controller means; and
means for transmitting a signal configured to facilitate locating the monitoring device.

19. The monitoring device of claim 18, further comprising means for presenting the information to the user transceiver.

20. The monitoring device of claim 18, further comprising a sensing means for monitoring a condition of the property or a condition proximate to the property.

21. The monitoring device of claim 18, further comprising means for recording and playing audible information regarding the condition of the property being monitored by the monitoring device.

22. The monitoring device of claim 18, wherein the monitoring device may be programmed to turn off and on at specified times.

23. A mobile security system for monitoring property, the system comprising:
a central processing unit;
a transceiver electrically coupled to the central processing unit;
the transceiver configured to receive programmable commands from a user transceiver;
the transceiver configured to contact the user transceiver in response to a change in the condition being monitored by the monitoring device;
a tracking device configured to transmit a tracking signal locatable by a user;
a sensing device configured to monitor a condition of the property; and
a microphone configured to collect audible information proximate to the security device.

24. A mobile monitoring device for monitoring property comprising:
a controller; and
a transceiver configured to receive programming commands from a user transceiver, the transceiver being coupled to the controller and configured to transmit information regarding the property being monitored to the user transceiver, the monitoring device being further configured to execute programming commands received from the user transceiver.

25. A mobile monitoring device as in claim 24 further comprising one or more sensing devices that are configured to monitor a condition of the property or a condition proximate to the property.

26. A mobile monitoring device as in claim 25 wherein the monitoring device is capable of executing a programming command to activate or deactivate one or more of the sensing devices.

27. A mobile monitoring device as in claim 25 wherein the monitoring device is configured to contact the user transceiver if the one or more of the sensing devices detect a change in a condition of the property or a change in a condition proximate to the property.

28. A mobile monitoring device as in claim 24 further comprising a tracking device configured to transmit a signal for locating the monitoring device.

29. A mobile monitoring device as in claim 28 wherein the monitoring device is capable of executing a programming command to activate or deactivate the tracking device.

30. A mobile monitoring device as in claim 24 further comprising a battery monitor.

31. A mobile monitoring device as in claim 30 wherein the monitoring device is capable of executing a programming command to activate or deactivate the battery monitor.

32. A mobile monitoring device as in claim 24 further comprising an interface device.

33. A mobile monitoring device as in claim 32 wherein the interface device is a microphone.

34. A mobile monitoring device as in claim 32 wherein the interface device is a voice module.

35. A mobile monitoring device as in claim 32 wherein the monitoring device is capable of executing a programming command to activate or deactivate the interface device.

36. A mobile monitoring device as in claim 24 wherein the monitoring device is capable of executing a programming command to turn on or off the monitoring device.

37. A mobile monitoring device as in claim 24 wherein the monitoring device is configured to attach to the property.

38. A mobile monitoring device as in claim 24 wherein the monitoring device is capable of executing a programming command to reset the monitoring device.

39. A mobile monitoring device as in claim 24 wherein the monitoring device is configured to send a confirmation to the user transceiver confirming that the programming command has been properly executed.

40. A mobile monitoring device as in claim 24 further comprising one or more satellite units.

41. A mobile monitoring device as in claim 24 wherein the device is remotely programmable.

42. A mobile monitoring device as in claim 24 wherein the monitoring device is capable of executing a programming command that will trigger an alarm.

43. A mobile monitoring device as in claim 24 wherein the monitoring device is configured such that a user may provide custom programming commands for a specific monitoring device positioned at a given location.

44. A mobile monitoring device as in claim 24 wherein the monitoring device is configured such that a user may provide programming commands to the monitoring device by using buttons on a phone.

45. A mobile monitoring device as in claim 24 wherein the monitoring device is configured such that a user may provide programming commands to one or more interface devices.

46. A method of improving security of property, the method comprising:
monitoring property with a mobile programmable monitoring device;
contacting a user transceiver if the programmable monitoring device detects a change in a condition of the property or a change in a condition proximate to the property; and
providing information pertaining to the condition of the property to the user transceiver.

47. The method of claim 46, further comprising the step of transmitting a signal configured to facilitate locating the monitoring device.

48. The method of claim 46, further comprising the step of executing a programming command received from the user transceiver.

49. The method of claim 48, further comprising the step of sending a confirmation to the user transceiver to confirm that the programming command has been executed.

50. The method of claim 48 wherein the programming command is a command to activate or deactivate a sensing device.

51. The method of claim 48 wherein the programming command is a command to activate or deactivate a tracking device.

52. The method of claim 48 wherein the programming command is a command to activate or deactivate an alarm.

53. The method of claim 48 wherein the programming command is a command to activate or deactivate an interface device.

54. The method of claim 48 wherein the programming command is a command to reset the monitoring device.

55. The method of claim 46 further comprising the step of verifying a password prior to providing information to the user transceiver.

56. The method of claim 46 wherein the information provided is audible information.

57. The method of claim 46 further comprising the step of reviewing the information provided to the user transceiver.

58. A method for programming a programmable mobile monitoring device comprising:
using a user transceiver to contact the programmable mobile monitoring device;
establishing communication between the user transceiver and the monitoring device; and
executing a programming command sent by the user transceiver to the monitoring device.

59. A method as in claim 58 further comprising the step of verifying a password prior to providing information to the user transceiver.

60. The method of claim 58, further comprising the step of sending a confirmation to the user transceiver to confirm that the programming command has been executed.

61. The method of claim 58, further comprising the step of providing information to the user transceiver after a communication has been established.

62. A mobile monitoring device comprising:
a controller; and
a transceiver configured to receiver programming commands from a user transceiver, the transceiver being coupled to the controller and configured to transmit information regarding a condition proximate to the monitoring device to the user transceiver, the monitoring device being further configured to execute programming commands received from the user transceiver.
